(19) United States
(12) Patent Application Publication
(10) Pub. No.: US 2005/0073924 A1
(43) Pub. Date: Apr. 7, 2005

(54) Controlling rotational speed of an optical disc based on detected eccentricity

(75) Inventor: Toshihiro Yamashiro, Kanagawa-ken (JP)

Correspondence Address: DICKSTEIN SHAPIRO MORIN & OSHINSKY LLP, 2101 L Street, NW, Washington, DC, 20037, US

(73) Assignee: Ricoh Company, Ltd.

(21) Appl. No.: 10/959,072

(22) Filed: Oct. 7, 2004

(30) Foreign Application Priority Data
Oct. 7, 2003 (JP) 2003-347978

(51) Int. Cl. G11B 7/00; G11B 5/09

(52) U.S. Cl. 369/47.36; 369/44.32; 369/53.14

(57) ABSTRACT

A method, program, apparatus, and medium for determining and controlling a rotational speed of an optical disc, capable of suppressing the influence from disc eccentricity, and an optical disc apparatus utilizing such method, program, or medium are disclosed. The optical disc apparatus includes a driving mechanism, a lighting mechanism, an eccentricity detecting mechanism, and a speed controlling mechanism. The driving mechanism rotates an optical disc at a specified rotational speed. The lighting mechanism emits a light to the optical disc through a focusing mechanism, and receives a reflected light from the optical disc. The eccentricity detecting mechanism detects the eccentricity of the optical disc, using positional information of the focusing mechanism extracted from the reflected light. The speed controlling mechanism adjusts the specified rotational speed according to the eccentricity.

### FIELD OF INVENTION

The present invention relates to controlling optical storage systems. In particular, the present invention relates to controlling the rotational speed of an optical disc to minimize the effects of disc eccentricity.

### BACKGROUND OF THE INVENTION

A typical optical disc apparatus reads or writes data from or onto an optical disc, by focusing a laser light onto the spiral tracks previously formed on the recording surface of the optical disc. However, the laser light may deviate from the spiral tracks if the optical disc has a large eccentricity, and cause errors in reading or writing. Eccentricity may correspond to the positional accuracy of the center hole of the optical disc.

In order to suppress the influence of eccentricity, a conventional optical disc apparatus detects eccentricity of the optical disc, and controls the rotational speed of the optical disc based on the detected eccentricity. The eccentricity is usually calculated based on the disc vibrations, which may be obtained through a focusing error signal or a tracking error signal. However, the focusing error signal and the tracking error signal are sensitive to the factors other than the eccentricity. As a result, the eccentricity calculated based on the focusing error signal or the tracking error signal tends to include a large amount of noise.

### SUMMARY OF THE INVENTION

Exemplary embodiments of the method, apparatus, program, and medium of the present invention provide an optical disc control system in which the eccentricity of an optical disc is detected with high accuracy by an eccentricity detecting mechanism. The detected eccentricity is used to control the rotational speed of an optical disc in order to minimize the affects of the eccentricity. The eccentricity detecting mechanism can detect the eccentricity of the optical disc by using, for example, positional information received from a focusing mechanism, or a lens position signal received from an objective lens assembly. For increased accuracy, the eccentricity detection mechanism may extract frequency information from the lens position signal by filtering the signal through a band pass filter.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic block diagram of an optical disc apparatus according to an exemplary embodiment of the invention;

FIG. 2 is a plain view illustrating a portion of the optical disc apparatus shown in FIG. 1;

FIG. 3 is a perspective view illustrating an exemplary structure of a pickup device of the optical disc apparatus shown in FIG. 1;

FIG. 4 is a plain view illustrating an exemplary surface of a photodetector incorporated in the pickup device shown in the optical disc apparatus of FIG. 1;

FIG. 5 is a plain view illustrating a light collecting system of the pickup device of the optical disc apparatus shown in FIG. 1;

FIG. 6 is a schematic block diagram illustrating an exemplary structure of a signal processor of the optical disc apparatus shown in FIG. 1;

FIG. 7 is a schematic block diagram illustrating an exemplary structure of a servo controller of the optical disc apparatus shown in FIG. 1;

FIG. 8 is a schematic block diagram illustrating another exemplary structure of the signal processor of the optical disc apparatus shown in FIG. 1;

FIG. 9 is a graph illustrating the frequency response of a band pass filter shown in FIG. 8;

FIG. 10 is a schematic diagram illustrating exemplary structures of a motor driver and a motor controller, respectively, of the optical disc apparatus shown in FIG. 1;

FIG. 11 is a flowchart illustrating an exemplary operation of determining an optimum rotational speed, according to an exemplary embodiment of the present invention;

FIG. 12 is a flowchart illustrating an exemplary operation of determining an optimum rotational speed, according to another exemplary embodiment of the present invention;

FIG. 13 is a flowchart illustrating an exemplary operation of determining an optimum rotational speed, according to another exemplary embodiment of the present invention;

FIGS. 14A and 14B are flowcharts illustrating an exemplary operation of writing data onto an optical disc, performed by the optical disc apparatus shown in FIG. 1; and

FIGS. 15A and 15B are flowcharts illustrating an exemplary operation of reading data from an optical disc, performed by the optical disc apparatus shown in FIG. 1.

### DETAILED DESCRIPTION OF THE INVENTION

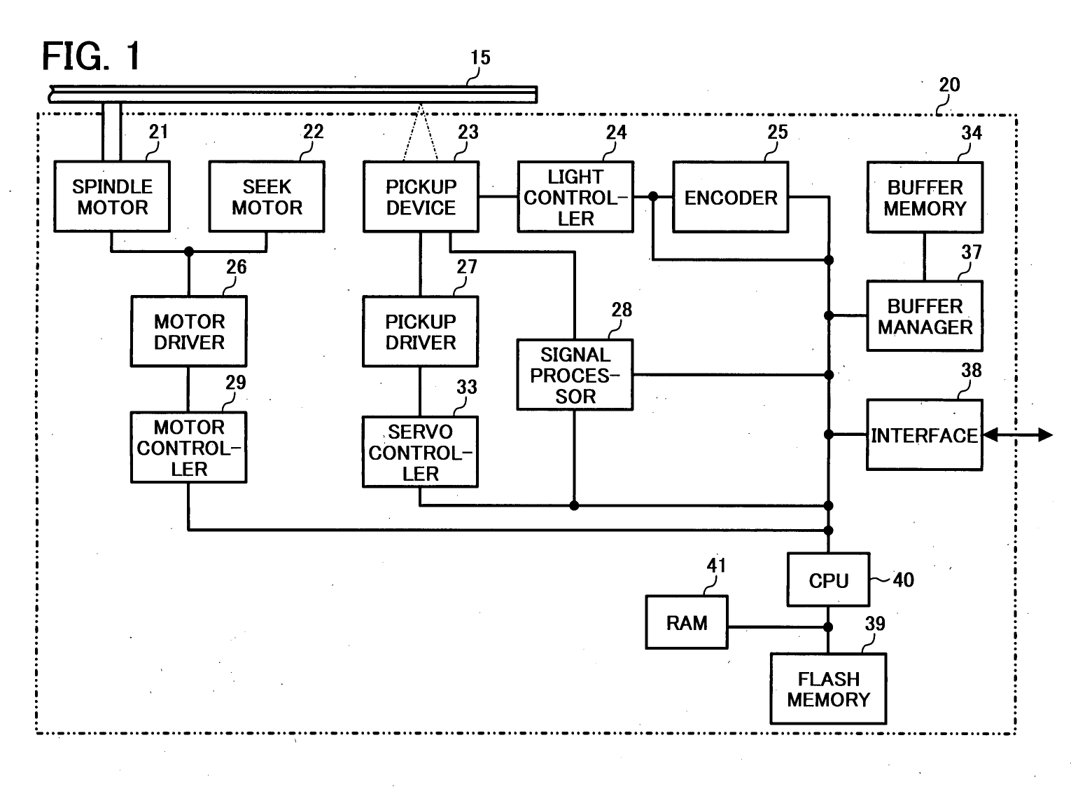

In describing preferred embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner. Referring now to the drawings, wherein like reference numerals designate identical or corresponding parts throughout the several views, particularly to FIG. 1, a description is made of an optical disc apparatus 20 according to a preferred embodiment of the present invention.

The optical disc apparatus 20 is capable of reading or writing data from or onto an optical disc 15, while suppressing the influence of eccentricity (referred to as the “eccentricity influence”) of the optical disc 15. The eccentricity influence includes disc vibrations, for example. The optical disc 15 includes any kind of optical media, such as CDs and DVDs.

As shown in FIG. 1, the optical disc apparatus 20 mainly includes a spindle motor 21, a seek motor 22, a pickup device 23, a light controller 24, an encoder 25, a motor driver 26, a pickup driver 27, a signal processor 28, a motor controller 29, a servo controller 33, a buffer memory 34, a buffer manager 37, an interface 38, a CPU (central processing unit) 40, a RAM (random access memory) 41, and a flash memory 39. It is to be noted that the connections shown in FIG. 1 represent flows of signals or information, rather than the mere physical connections.

The spindle motor 21 rotates the optical disc 15 with a predetermined rotational speed. Such rotational speed may be expressed in terms of linear or angular velocity.

The seek motor 22 moves the pickup device 23 to the position corresponding to a target point of the optical disc 15 during reading or writing operation.

The spindle motor 21 and the seek motor 22 are driven, respectively, by the motor driver 26 according to control signals generated from the motor controller 29 under instruction of the CPU 40. For example, the CPU 40 controls the spindle motor 21 to rotate with an optimum rotational speed, which can suppress the eccentricity influence.

The pickup device 23 irradiates a light to a target point on the recording surface of the optical disc 15, and receives the resultant reflected light. Based on the reflected light, the pickup device 23 generates electric signals used for reading or writing data from or onto the optical disc 15. The pickup device 23 is driven by the pickup driver 27.

The signal processor 28 extracts necessary information from the electric signals output from the pickup device 23, and provides such information to other devices.

For example, the signal processor 28 extracts information necessary for tracking and focusing, and sends such information to the servo controller 33. Based on this information, the servo controller 33 generates control signals for controlling tracking and focusing, and provides them to the pickup driver 27.

Additionally, the signal processor 28 extracts information indicating how much the optical disc 15 vibrates, and sends such information to the CPU 40. Based on this information, the CPU 40 determines the optimum rotational speed, which can suppress the eccentricity influence.

The buffer memory 34 includes a data buffer area and a program variable area. The data buffer area temporarily stores data that has been read out from the optical disc 15, i.e., the reproduced data. The data buffer area additionally stores data to be recorded onto the optical disc 15, i.e., the recorded data. The program variable area stores variable data to be used by the CPU 40.

The buffer manager 37 manages the amount of data stored in the buffer memory 34, by checking input or output of data. For example, when the amount of data in the buffer memory 34 reaches a predetermined level, the buffer manager 37 notifies the CPU 40 that no more data can be stored in the buffer memory 34.

The encoder 25 reads out the recorded data accumulated in the buffer memory 34 via the buffer manager 37, and generates a writing signal based on the recorded data. Before generating the writing signal, the encoder 25 may apply modulation and add an error correction code to the recorded data. In addition to the writing signal, the encoder 25 generates a clock signal Wck, which represents a reference clock signal generated from an oscillator (not shown).

The light controller 24 controls the amount of the light emitted from the pickup device 23, according to the writing signal. For example, when recording, the light controller 24 generates a light driving signal for driving a semiconductor laser (not shown) of the optical pickup device 23, according to various writing conditions including a luminance characteristic of the semiconductor laser, the writing signal received from the encoder 25, and the clock signal Wck.

The interface 38 allows a two-way communication between the optical disc apparatus 20 and other apparatuses. The interface 38 may be in compliance with any one of the standards including the ATAPI (AT Attachment Packet Interface), ATA (AT Attachment), SCSI (Small Computer System Interface), USB (Universal Serial Bus) 1.0, USB 2.0, IEEE 1394, IEEE 802.3, Serial ATA, and Serial ATAPI, for example.

The flash memory 39 includes a program area and a data area. The program area stores various programs that are readable to the CPU 40, including a program for determining an optimum rotational speed (“disc speed determining program”), a program for controlling the rotational speed of an optical disc (“disc speed controlling program”), a program for writing data onto an optical disc (“data writing program”), and a program for reading data from an optical disc (“data reading program”). The data area stores information, including information regarding the luminance characteristic of the semiconductor laser, the seek operation of the optical pickup device 23, and the various writing conditions. The data area may further store information indicating the relationship between disc vibration and eccentricity, and information indicating the relationship between eccentricity and rotational speed of the optical disc 15. Such information may be previously prepared, during manufacturing, inspection, or checking process of the optical disc apparatus 20 or the optical disc 15.

The CPU 40 controls an entire operation of the optical disc apparatus 20, according to at least one of the programs stored in the flash memory 39. The CPU 40 further stores necessary data in the program variable area of the buffer memory 34 and/or the RAM 41.

The CPU 40 may include an analog/digital converter (not shown) and/or a digital/analog converter (not shown).

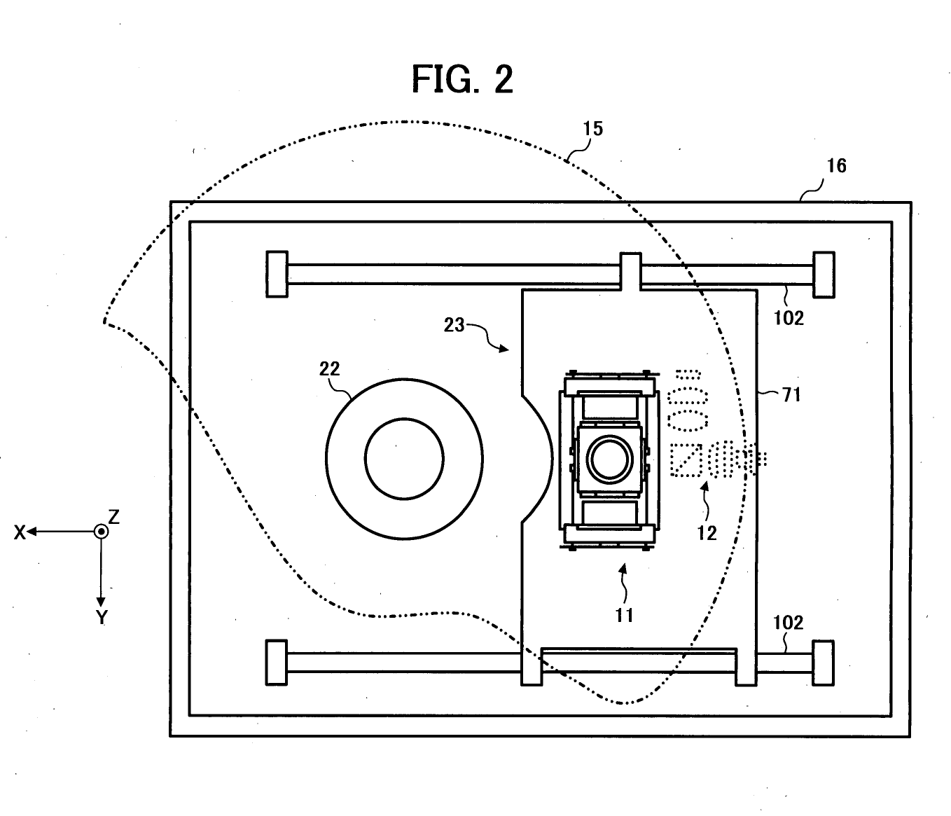

Referring now to FIGS. 2 to 5, an exemplary structure of the pickup device 23 is explained.

As shown in FIG. 2, the pickup device 23 is assembled on a platform 16 via two parallel rails 102. At least one of the rails 102 is rotated by the seek motor 22 (FIG. 1). With this rotation, the pickup device 23 moves in the direction indicated as X and the direction opposite to the X direction (collectively, the tracking direction).

The pickup device 23 mainly includes a light collecting system 11 and a light emitting system 12. The light collecting system 11 is formed on a housing 71. The light emitting system 12 is stored inside the housing 71.

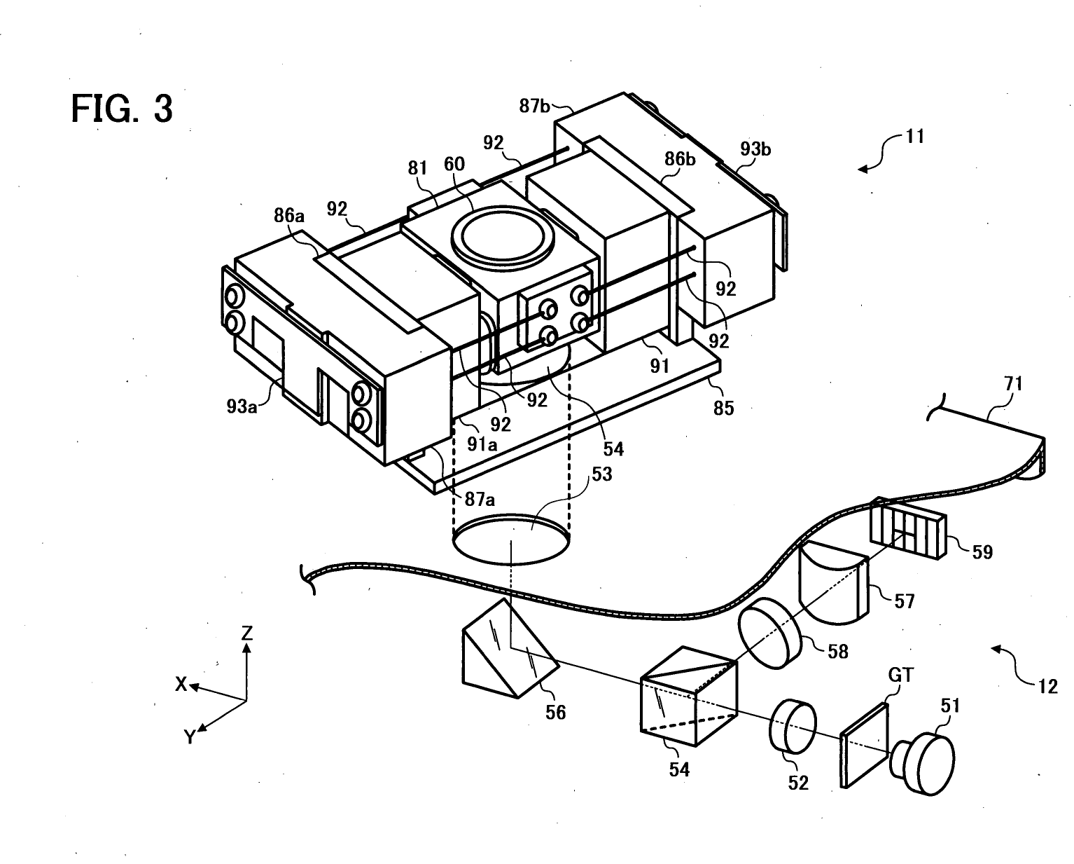

Referring to FIG. 3, the light emitting system 12 includes a lighting unit 51, a grating GT, a collimator lens 52, a beam splitter 54, a turning mirror 56, a detection lens 58, a cylindrical lens 57, and a photodetector 59.

The lighting unit 51 includes the semiconductor laser (not shown) capable of emitting a laser beam having a wavelength of 660 nm, for example. For optimal performance, the lighting unit 51 may be fixed in the housing 71 at a predetermined position such that it can emit a laser beam of maximum intensity in the X direction.

In the above exemplary case, the wavelength of 660 nm is used, however, any wavelength may be used, including 405 nm, 660 nm, and 780 nm, for example. Alternatively, the lighting unit 51 may include a plurality of semiconductor lasers, each capable of emitting a laser beam having a specific wavelength. In such a case, the lighting unit 51 can emit a laser beam of various wavelengths in compliance with various standards.

The grating GT, arranged in the X direction of the lighting unit 51, divides the laser beam emitted from the lighting unit 51 into multiple beams. In this particular example, the grating GT splits the laser beam into one main beam, and two side beams including a first side beam and a second side beam. The main beam is used mainly for data reading/writing and focusing. The side beams are used mainly for tracking.

The collimator lens 52, arranged in the X direction of the grating GT, makes the multiple beams substantially parallel to one another.

The multiple beams then pass through the beam splitter 54, arranged in the X direction of the collimator lens 52, and reach the turning mirror 56.

The turning mirror 56 redirects the multiple beams toward the direction indicated as Z. The redirected beams pass through the housing 71 to an objective lens 60 of the light collecting system 11. As shown in FIG. 3, the housing 71 has an opening 53, which allows the beams to travel from the light emitting system 12 to the light collecting system 11. For this reason, the dimension of the opening 53 corresponds to that of the objective lens 60.

After reaching the objective lens 60, the beams are converged and irradiated onto the recording surface of the optical disc 15 (FIG. 2), which is placed right above the light collecting system 11. With this irradiation, the optical disc 15 forms an optical spot on its recording surface, and generates the reflected beams corresponding to the optical spot.

The objective lens 60 receives the reflected beams, makes them substantially parallel, and passes the beams to the turning mirror 56 via the opening 53.

The turning mirror 56 directs the reflected beams toward the beam splitter 54. The beam splitter 54 turns the reflected beams toward the direction opposite to the direction indicated as Y.

The detection lens 58 converges the reflected beams received from the beam splitter 54, and forms an optical spot on the light receiving surface of the photodetector 59.

To make the optical spot circular, the cylindrical lens 59 controls the horizontal and vertical focal distances of the optical spot formed on the photodetector 59, by changing its position between the detection lens 58 and the photodetector 59.

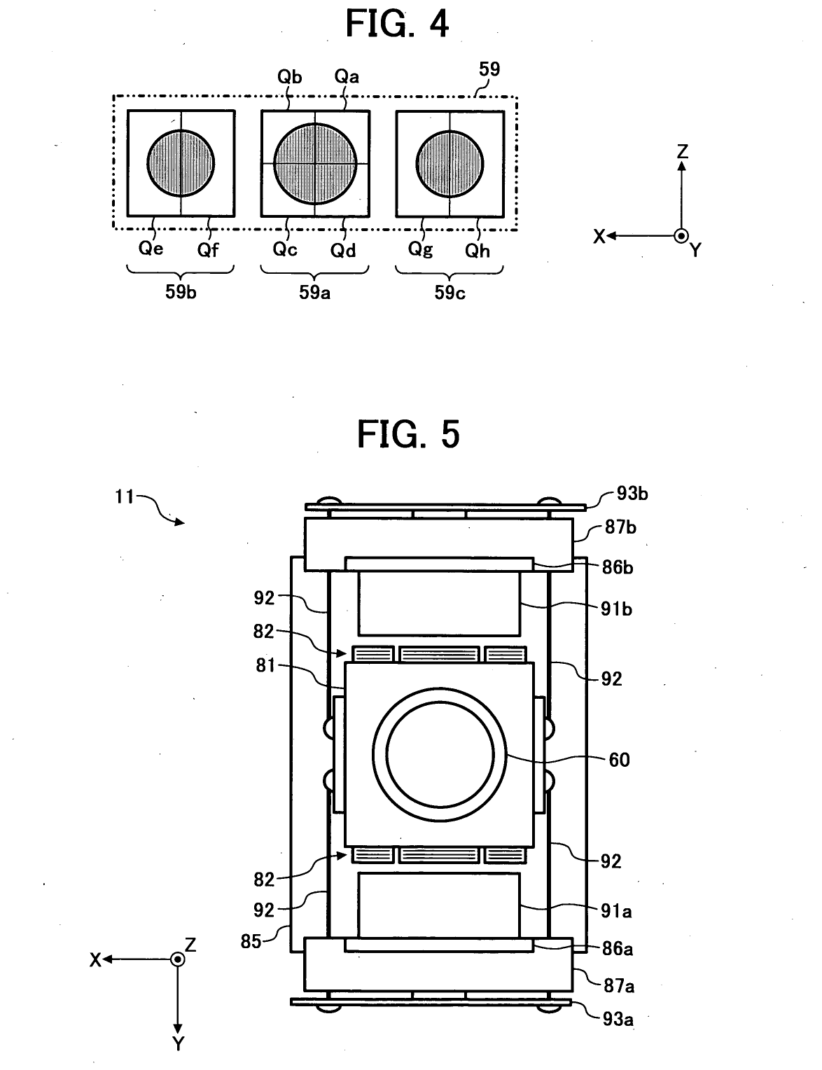

As shown in FIG. 4, the surface of the photodetector 59 may be divided into three sections including a main section 59a, a first side section 59b, and a second side section 59c.

The main section 59a is divided into four quadrants Qa, Qb, Qc, and Qd, which are substantially equal in dimension. The main section 59a receives the main beam, forms a main optical spot of circular shape corresponding to the main beam, and generates a main electric signal corresponding to the main optical spot.

The first side section 59b is divided into two quadrants Qe and Qf, which are substantially equal in dimension. The first side section 59b receives the first side beam, forms a first side optical spot of circular shape corresponding to the first side beam, and generates a first side electric signal corresponding to the first side optical spot.

The second side section 59c is divided into two quadrants Qg and Qh, which are substantially equal in dimension. The second side section 59c receives the second side beam, forms a second side optical spot of circular shape corresponding to the second side beam, and generates a second side electric signal corresponding to the second side optical spot.

These electric signals are output to the signal processor 28 for further processing.

Referring back to FIG. 3, the light collecting system 11 mainly includes a lens holder 81, a base plate 85, a pair of magnets 91a and 91b, and a pair of connectors 87a and 87b.

The base plate 85 includes an opening 54, having a dimension substantially same with the dimension of the opening 53 of the housing 71. The base plate 85 is attached onto the housing 71 such that the opening 54 covers the opening 53. Further, the longitudinal side of the base plate 85 extends towards the Y direction and its opposite direction. The lateral side of the base plate 85 extends in the tracking direction.

The lens holder 81, holding the objective lens 60 in its central portion, is placed between the magnets 91a and 91b, at a position right above the opening 54 of the base plate 85. The lens holder 81 includes an opening (not shown), which serves as an optical path allowing the beams to travel through. Thus, the dimension of such opening corresponds to that of the opening 54.

The connector 87a is formed on the base plate 85, particularly, at one of its lateral sides. The connector 87b is formed on the base plate 85, particularly, at another one of the lateral sides. Thus, the connector 87a and the connector 87b face each other across the lens holder 81.

The connector 87a has the inner side facing the lens holder 81, and the outer side facing away from the lens holder 81. A yoke 86a is provided on the inner side, while a circuit board 93a is provided on the outer side.

Similarly, the connector 87b has the inner side facing the lens holder 81, and the outer side facing away from the lens holder 81. A yoke 86b is provided on the inner side, while a circuit board 93b is provided on the outer side.

The magnet 91a is attached to the yoke 86a of the connector 87a. The magnet 91b is attached to the yoke 86b of the connector 87b. In other words, the magnets 91a and 91b are placed above the base plate 85, while facing each other across the lens holder 81.

As shown in FIG. 3, the lens holder 81 is connected to the connectors 87a and 87b via a plurality of wire springs 92. Thus, the lens holder 81, including the objective lens 60, moves as the connectors 87a and 87b vibrate integrally with the base plate 85. In other words, when the optical disc 15 having a large eccentricity causes disc vibrations, such vibrations are transmitted to the lens holder 81 through the base plate 85.

Further, as shown in FIG. 5, the lens holder 81 includes a plurality of drive coils 82 at its side surfaces. The plurality of drive coils 82 includes, for example, a focusing coil for driving the lens holder 81 in the focusing direction (that is, the Z direction and the direction opposite to the Z direction), and a tracking coil for driving the lens holder 81 in the tracking direction. Each of the drive coils 82 has an input terminal, which is provided on a circuit board mounted on the side surface of the lens holder 81, and an output terminal, which is formed on the circuit board 93a or 93b.

With this structure, the pickup device 23 performs focusing and tracking operations. For example, when the focusing operation is needed, the pickup device 23 provides a focusing drive current to the focusing coil. As a result, an electromotive force is generated, which can drive the lens holder 81 in the focusing direction. In another example, when the tracking operation is needed, the pickup device 23 provides a tracking drive current to the tracking coil. This generates an electromotive force, which can drive the lens holder 81 in the tracking direction. The tracking operation is performed, particularly when the lens holder 81 is moved by the disc vibrations, as described above. Through the focusing and tracking operations, the pickup device 23 can form an optical spot, accurately onto a specific target point of the optical disc 15.

During the focusing and tracking operations, the pickup device 23 provides the focusing drive current and the tracking drive current, respectively, as mentioned above. These drive currents are generated based on driving signals output from the pickup driver 27. The pickup driver 27 generates the driving signals from the control signals output from the servo controller 33. The servo controller 33 generates the control signals based on the electric signals output from the signal processor 28.

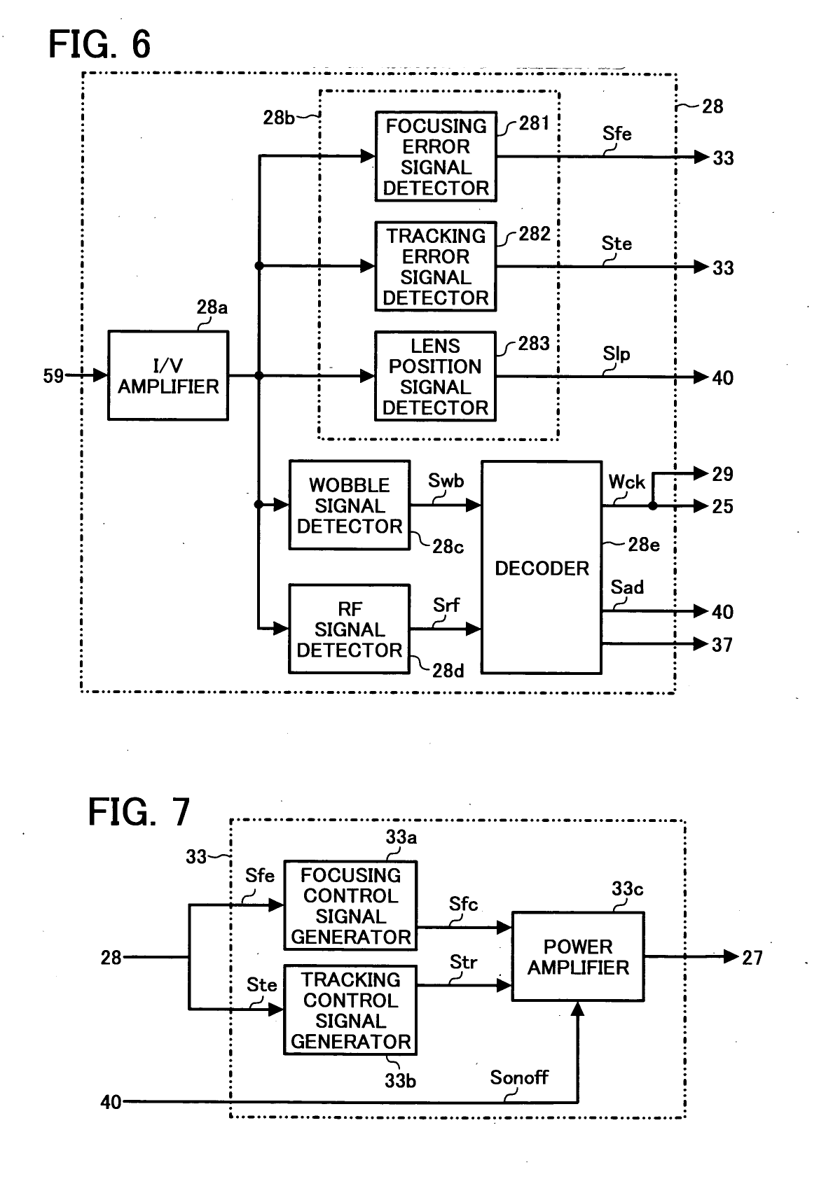

As shown in FIG. 6, the signal processor 28 includes an I/V (inverting) amplifier 28a, a servo signal detector 28b, a wobble signal detector 28c, an RF (radio frequency) signal detector 28d, and a decoder 28e. The I/V amplifier 28a converts the electric signals received from the photodetector 59 (FIG. 3) to voltage signals, and amplifies the voltage signals with a predetermined gain. The wobble signal detector 28c extracts a wobble signal Swb from the voltage signals, and outputs it to the decoder 28e. The RF signal detector 28d extracts an RF signal Srf from the voltage signals, and outputs it to the decoder 28e. The decoder 28e extracts various information, such as address information and synchronized information, from the wobble signal Swb. The extracted address information is output to the CPU 40. The synchronized information is output to the encoder 25 and the motor controller 29, for example, as the clock signal Wck. In addition, the decoder 28e decodes the RF signal Srf and/or corrects its errors, and stores the decoded RF signal as reproduced data in the buffer memory 34 (FIG. 1) via the buffer manager 37 (FIG. 1). At the same time, address information contained in the RF signal is output to the CPU 40 (FIG. 1).

The servo signal detector 28b includes a focusing error signal detector 281, a tracking error signal detector 282, and a lens position signal detector 283.

The focusing error signal detector 281 extracts a focusing error signal Sfe from the voltage signals output from the I/V amplifier 28a, and outputs it to the servo controller 33. More specifically, the focusing error signal Sfe corresponds to the main electric signal generated by the photodector 59.

The tracking error signal detector 282 extracts a tracking error signal Ste from the voltage signals output from the I/V amplifier 28a, and outputs it to the servo controller 33. More specifically, the tracking error signal Ste corresponds to the side electric signals generated by the photodector 59.

The lens position signal detector 283 extracts a lens position signal Slp from the voltage signals output from the I/V amplifier 28a, and outputs it to the CPU 40. The lens position signal Slp indicates the vibration of the lens holder 81, caused by the disc vibrations of the optical disc 15.

As shown in FIG. 7, the servo controller 33 includes a focusing control signal generator 33a, a tracking control signal generator 33b, and a power amplifier 33c.

The focusing control signal generator 33a generates a focusing control signal Sfc based on the focusing error signal Sfe output from the focusing error signal detector 281, and output it to the power amplifier 33c.

The tracking control signal generator 33b generates a tracking control signal Str based on the tracking error signal Ste received from the tracking error signal detector 282, and outputs it to the power amplifier 33c.

The power amplifier 33c outputs at least one of the focusing control signal Sfc and the tracking control signal Str to the pickup driver 27, after amplifying it with a predetermined gain.

The CPU 40 controls output of the focusing control signal Sfc and the tracking control signal Str, respectively.

For example, when the focusing operation is needed, the CPU 40 generates a servo-on signal Son, and causes the power amplifier 33c to output the focusing control signal Sfc. Otherwise, the CPU 40 generates a servo-off signal Soff, instructing the power amplifier 33c to stop output of the focusing control signal Sfc.

When the tracking operation is needed, the CPU 40 generates a servo-on signal Son, and causes the power amplifier 33c to output the tracking control signal Str. Otherwise, the CPU 40 generates a servo-off signal Soff, instructing the power amplifier 33c to stop output of the tracking control signal Str.

Further, when detecting the eccentricity influence, such as the disc vibrations, through the lens position signal Slp, the CPU 40 may send a servo-off signal to the power amplifier 33c to stop output of the tracking control signal Str. In this way, the eccentricity influence may be detected more effectively.

The pickup driver 27 generates a focusing drive signal according to the focusing control signal Sfc, and outputs it to the pickup device 23. As a result, the pickup device 23 moves in the focusing direction.

In addition, the pickup driver 27 generates a tracking drive signal according to the tracking control signal Str, and outputs it to the pickup device 23. As a result, the pickup device 23 moves in the tracking direction.

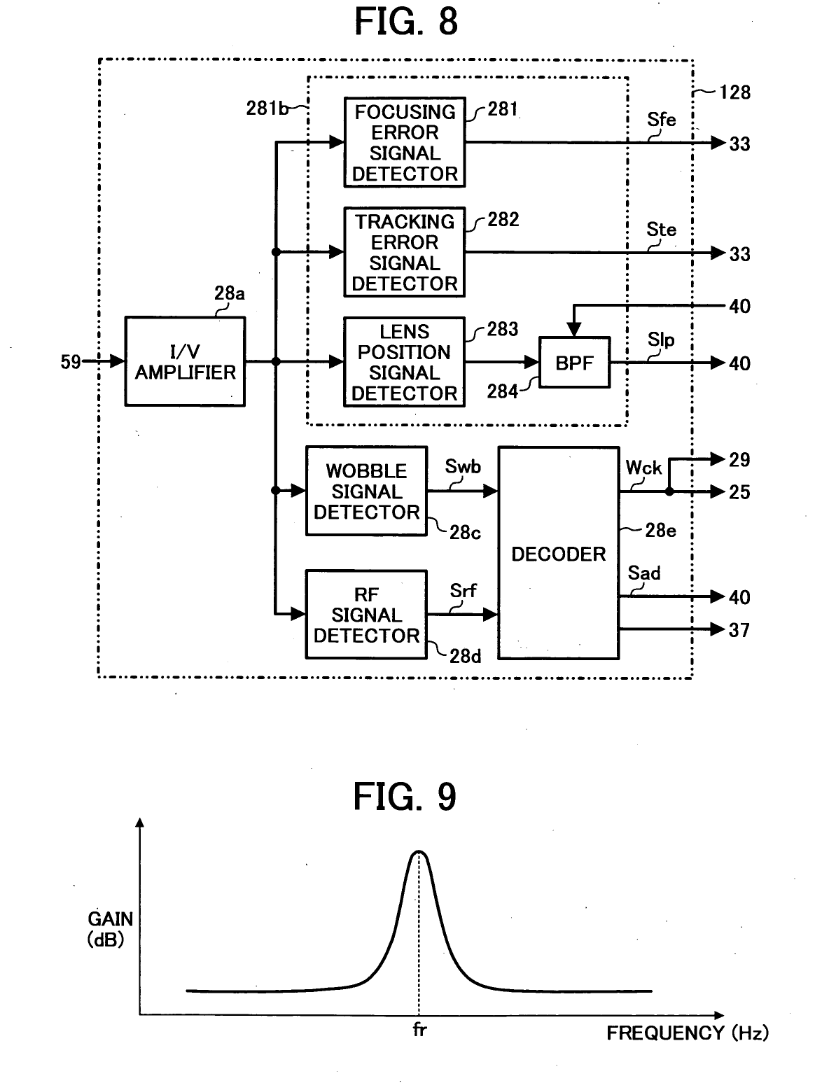

When compared to the conventional case of using the focusing error signal Sfe or the tracking error signal Ste, the use of the lens position signal Slp substantially reduces the amount of noise attributable to factors other than the eccentricity. To further reduce the amount of noise, the signal processor 28 may be replaced with a signal processor 128 of FIG. 8, for example.

The signal processor 128 is substantially similar in structure to the signal processor 28, except for the addition of a BPF (band pass filter) 284 provided in a servo signal detector 281b.

FIG. 9 illustrates the frequency response of the BPF 284. As shown in FIG. 9, the BPF 284 has a gain having the highest value around its center frequency fr. In other words, the BPF 284 passes frequencies around the center frequency fr, while rejecting frequencies outside the upper and lower limits of the center frequency fr. The CPU 40 may previously set the center frequency fr to the frequency corresponding to the rotational speed of the optical disc 15 (measured in revolutions per minute, for example).

With this BPF 284, the amount of noise contained in the lens position signal Slp is substantially reduced. Thus, the rotational speed of the optical disc 15 may be controlled more effectively, using the les position signal Slp. The rotational speed of the optical disc 15 is controlled by changing the rotation of the spindle motor 21, via the motor driver 26 and the motor controller 29.

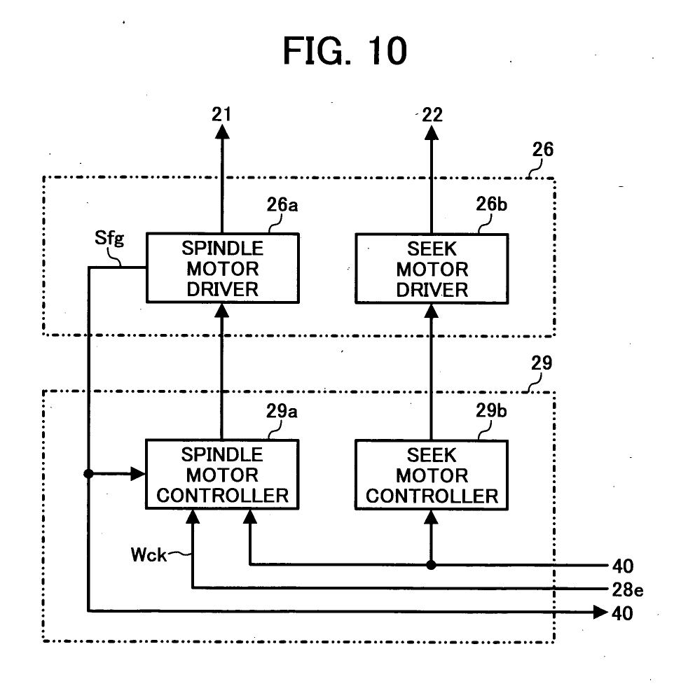

FIG. 10 illustrates exemplary structures of the motor driver 26 and the motor controller 29, respectively.

As shown in FIG. 10, the motor driver 26 includes a spindle motor driver 26a and a seek motor driver 26b. The motor controller 29 includes a spindle motor controller 29a and a seek motor controller 29b.

The spindle motor controller 29a generates a rotation control signal corresponding to the optimum rotational speed determined by the CPU 40. The spindle motor driver 26a generates a drive signal corresponding to the rotation control signal, and outputs it to the spindle motor 21. In addition, the spindle motor driver 26a generates an FG (frequency generator) signal Sfg, which indicates a current rotational speed of the optical disc 15, and outputs it to the spindle motor controller 29a and to the CPU 40.

In other words, the motor driver 26 adjusts the clock signal Wck to be synchronized with the rotation control signal, and further adjusts the FG signal Sfg to be synchronized with the clock signal Wck. In this way, the spindle motor 21 can rotate the optical disc 15 at the optimum rotational speed.

The seek motor controller 29b generates a seek motor control signal for controlling the drive of the seek motor 22 according to the instruction output from the CPU 40. The seek motor driver 26b generates a drive signal according to the seek motor control signal received from the seek motor controller 29b, and outputs it to the seek motor 22.

In the above and other examples of the present invention, the CPU 40 determines the optimum rotational speed, based on the lens position signal Slp including information regarding the eccentricity influence.

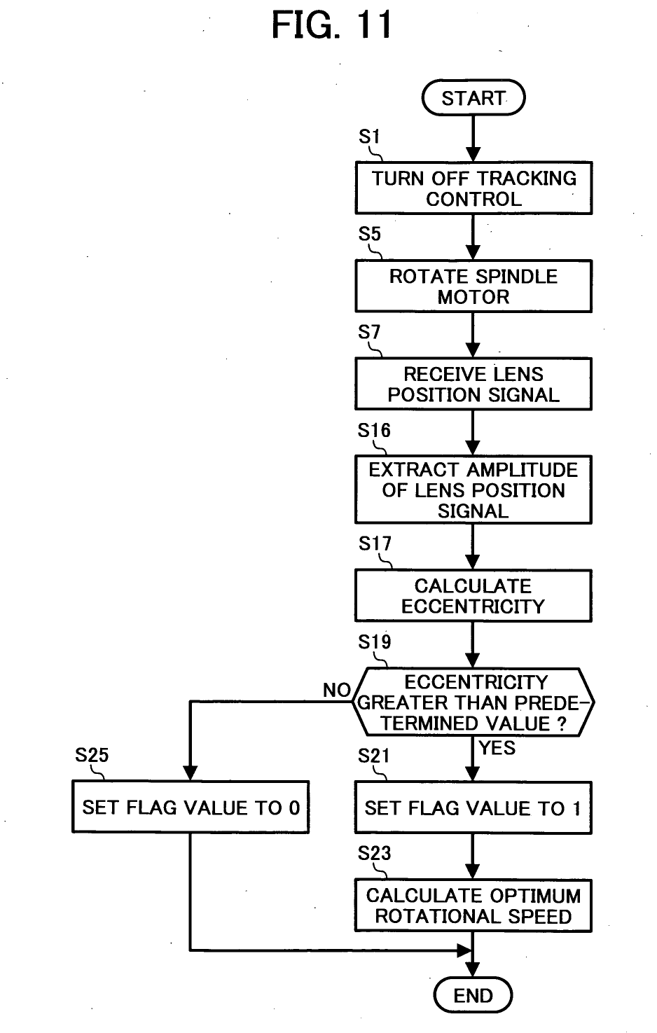

Referring now to FIG. 11, an exemplary operation of determining an optimum rotational speed, performed by the optical disc apparatus 20 is explained. The steps illustrated in FIG. 11 are performed by the CPU 40, according to the disc speed determining program. More specifically, when the optical disc 15 is mounted on the optical disc apparatus 20, the disc speed determining program is loaded from the flash memory 39 onto the RAM 41. At the same time, the optical disc apparatus 20 starts operating according to the disc speed determining program.

In step S1, the CPU 40 instructs the servo controller 33 to stop the output of the tracking control signal Ste, while allowing the servo controller 33 to output the focusing control signal Sfc. Thus, the pickup driver 27 generates a focusing drive signal based on the focusing control signal, and adjusts the focusing direction of the pickup device 23.

In step S5, the spindle motor 21 rotates the optical disc 15 at a predetermined rotational speed. At the same time, the CPU 40 sets the center frequency fr of the BPF 284 to this predetermined rotational speed, when the BPF 284 is applied for noise reduction. The predetermined rotational speed depends on the specification of the optical disc 15 in use.

In step S7, the signal processor 28 extracts the lens position signal Slp from electrical signals received from the pickup device 23, and applies filtering using the BPF 284 before outputting it to the CPU 40.

In step S16, the CPU 40 extracts the amplitude of the lens position signal Slp.

In step S17, the CPU 40 calculates eccentricity of the optical disc 15, using the amplitude of the lens position signal Slp. In this case, a lookup table illustrating the relationship between the amplitude of the lens positional signal and the eccentricity of the optical disc 15 may be prepared previously based on experimental, simulation or calculation results. In one example, the eccentricity is proportional to the amplitude of the lens position signal. In another example, the eccentricity is proportional to the square root mean of the amplitude of the lens position signal.

Once the lookup table is stored in the data area of the flash memory 39, for example, the CPU 40 can easily refer to the lookup table to find out the eccentricity corresponding to the obtained amplitude of the lens position signal Slp.

In step S19, the CPU 40 determines whether the obtained eccentricity is greater than a predetermined value. If yes, the process moves to Step S21 to set the flag value to 1 and store the flag value of 1 in the RAM 41.

Otherwise, the process moves to Step S25 to set the flag value to 0 and store the flag value of 0 in the RAM 41.

In step S23, the CPU 40 obtains the optimum rotational speed corresponding to the calculated eccentricity value.

In this case, a lookup table illustrating the relationship between the eccentricity and the optimum rotational speed of the optical disc 15 may be prepared previously based on experimental, simulation or calculation results. Generally, the optimum rotational speed is inversely proportional to the eccentricity.

Once the lookup table is stored in the data area of the flash memory 39, for example, the CPU 40 can easily refer to the lookup table to find out the optimum rotational speed corresponding to the obtained eccentricity.

At the same time, the CPU 40 stores the optimum rotational speed in the RAM 41.

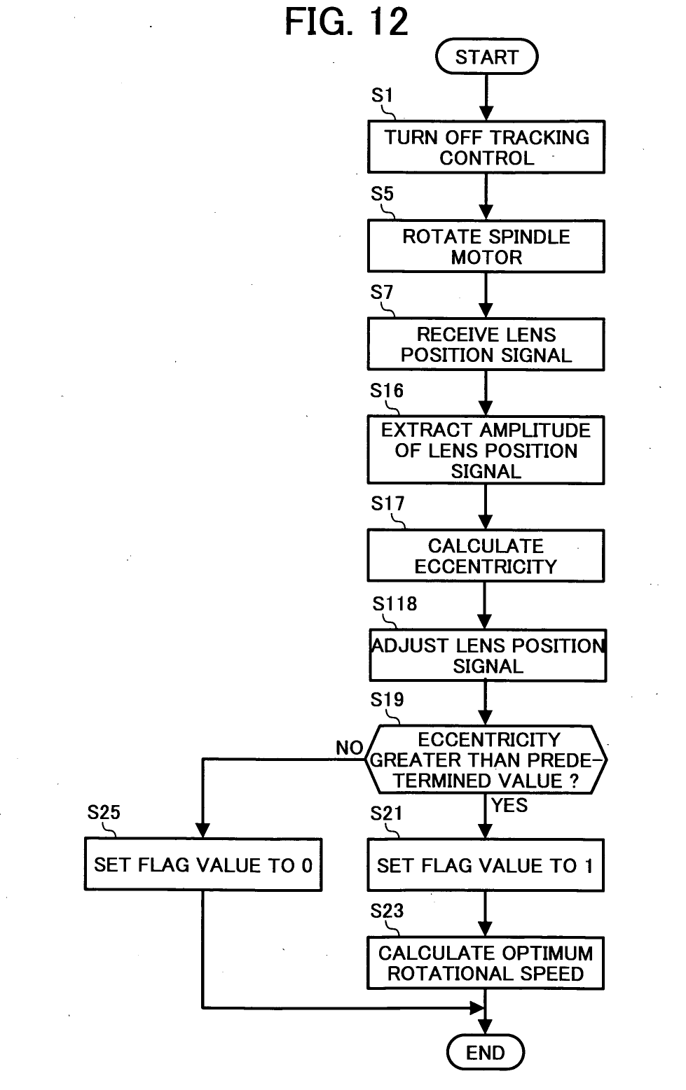

FIG. 12 illustrates another exemplary operation of determining the optimum rotational speed, performed by the optical disc apparatus 20. The steps shown in FIG. 12 are substantially similar to those shown in FIG. 11, except for the addition of Step S118.

In step S118, the CPU 40 adjusts the amplitude of the lens position signal Slp obtained in the previous step, using the interpolation technique or approximation technique. In this way, the disc vibration attributable to external factors other than the eccentricity may be substantially reduced. Such external factors include, for example, environmental conditions, setting conditions of the optical disc apparatus 20, and natural measurement errors.

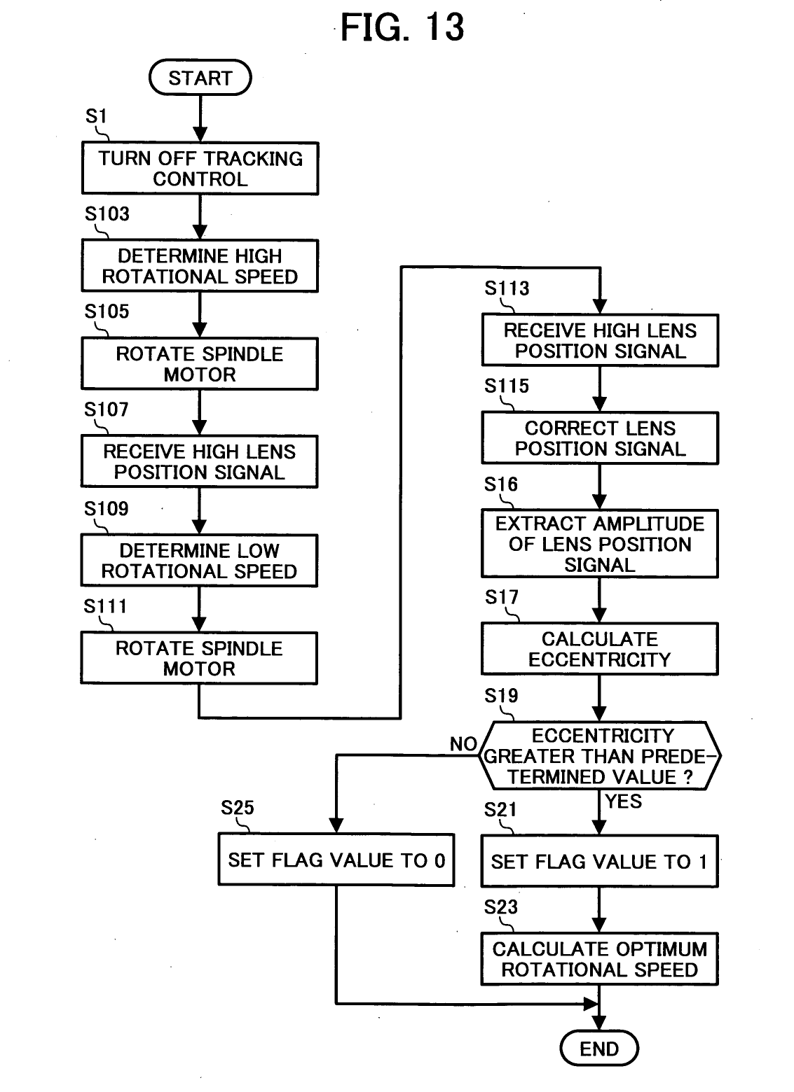

FIG. 13 illustrates another exemplary operation of determining the optimum rotational speed, performed by the optical disc apparatus 20. The steps shown in FIG. 13 are substantially similar to those shown in FIG. 11, except that Steps S3 to S15 are replaced with Steps S103 to S115.

In step S103, the CPU 40 sets the rotational speed of the optical disc 15 to its high rotational speed. In this exemplary case, the CPU 40 uses 4× speed as the high rotational speed. However, any higher rotational speed may be used, as long as it can generate a sufficient amount of disc vibrations attributable to eccentricity.

At the same time, the CPU 40 sets the high rotational speed as the center frequency fr, if the BPF 284 is applied.

In step S105, the CPU 40 rotates the spindle motor 21 at the high rotational speed.

In step S107, the CPU 40 receives the lens position signal Slp corresponding to the high rotational speed from the signal processor 28, in a similar manner as described referring to Step S7 of FIG. 11.

In step S109, the CPU 40 sets the rotational speed of the optical disc 15 to its low rotational speed. In this exemplary case, the CPU 40 uses 1× speed as the low rotational speed. However, any lower rotational speed may be used, as long as it can reduce a sufficient amount of disc vibrations attributable to eccentricity.

At the same time, the CPU 40 sets the low rotational speed as the center frequency fr, if the BPF 284 is applied.

In step S11l, the CPU 40 rotates the spindle motor 21 at the low rotational speed.

In step S113, the CPU 40 receives the lens position signal Slp corresponding to the low rotational speed from the signal processor 28, in a similar manner as described referring to Step S7 of FIG. 11.

In step S115, the CPU 40 adjusts the value of the lens position signal Slp obtained at the high rotational speed, using the value of the lens position signal Slp obtained at the low rotational speed. In this way, the disc vibration attributable to the external factors other than the eccentricity may be substantially reduced.

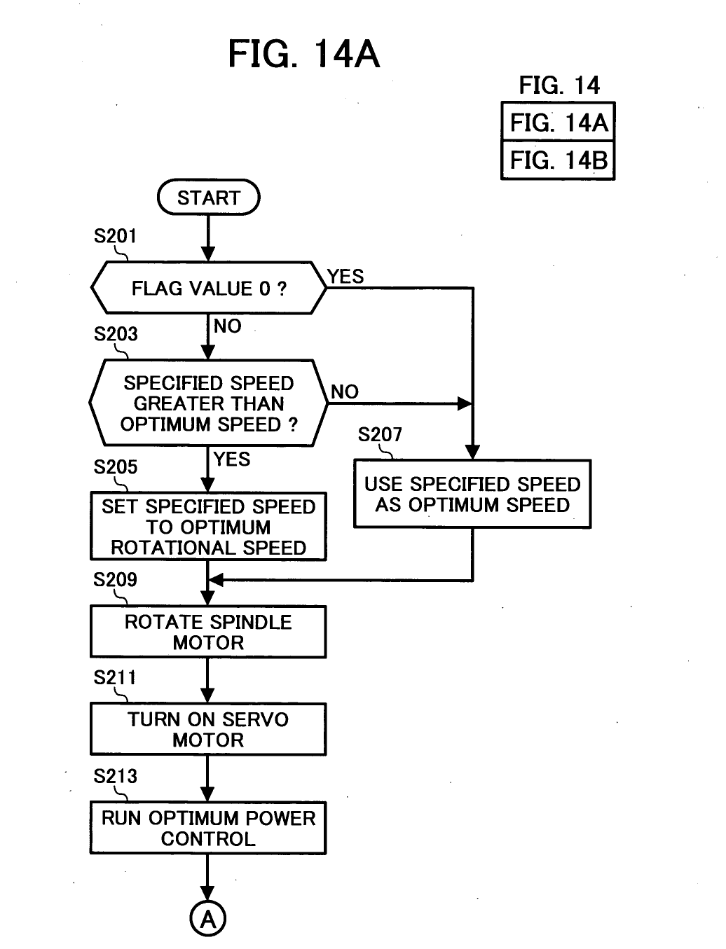

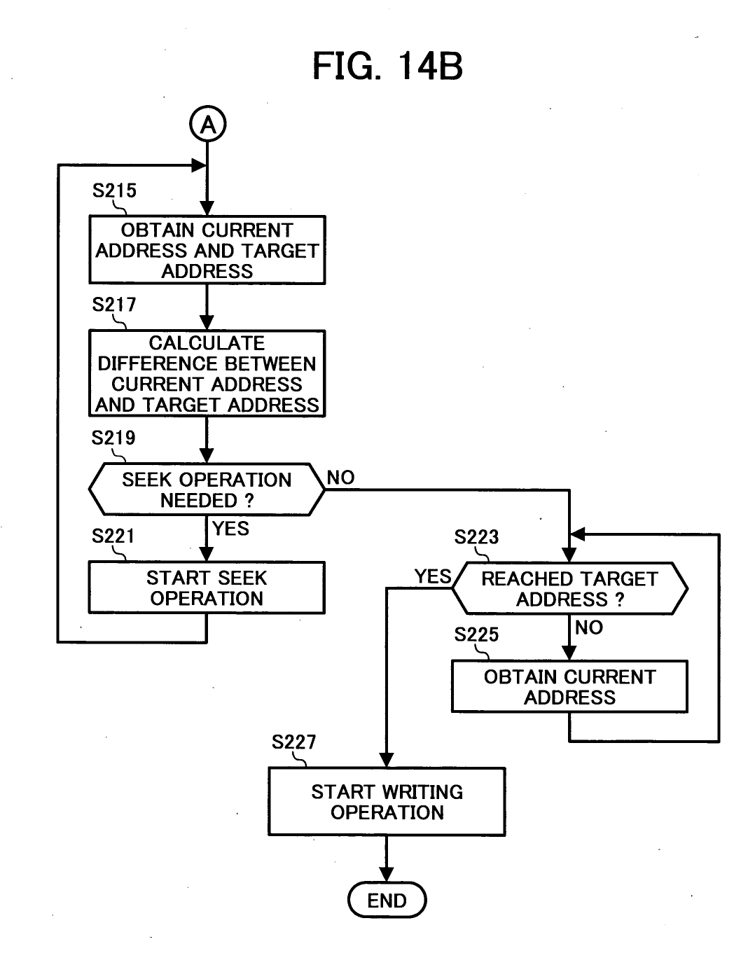

Next, an exemplarity operation of recording data onto the optical disc 15, performed by the optical disc 20, is explained with reference to FIGS. 14A and 14B. The steps shown in FIGS. 14A and 14B are performed by the CPU 40 according to the data writing program stored in the flash memory 39. More specifically, when the CPU 40 receives a command from a user to record data at a specified rotational speed, the data writing program is loaded from the flash memory 39 onto the RAM 41. At the same time, the CPU 40 starts operating according to the data writing program.

In step S201 of FIG. 14A, the CPU 40 determines whether the flag value indicates 0. If yes, the process moves to Step S207 to determine to use the specified rotational speed as the optimum rotational speed, and further to step S209. Otherwise, the process moves to Step S203.

In step S203, the CPU 40 determines whether the specified rotational speed is greater than the optimum rotational speed that has been previously determined in the steps shown in any one of FIGS. 11 to 13. If no, the process moves to Step S207. Otherwise, the process moves to Step S205.

In step S205, the CPU 40 determines to use the optimum rotational speed as the optimum rotational speed.

In step S209, the CPU 40 instructs the motor controller 29 to rotate the optical disc 15 at the optimum rotational speed. The CPU 40 then notifies the signal processor 28 that the command for writing data has been received. Further, the CPU 40 instructs the buffer manager 37 to receive the data to be recorded and store it into the buffer memory 34.

In step S211, after the CPU 40 determines that the rotational speed of the optical disc 15 has reached the optimum rotational speed, the CPU 40 actives the servo controller 33. The servo controller 33 controls the pickup device 23 through focusing and tracking operations.

In step S213, the CPU 40 runs an OPC (optimum power control) to obtain the optimum laser power for recording. The CPU 40 may continuously run the optimum power control during the entire recording operation.

In step S215 of FIG. 14B, the CPU 40 obtains a current address based on the address information output from the decoder 28e of the signal processor 28, and a target address from the received command.

In step S217, the CPU 40 calculates the address difference between the current address and the target address.

In step S219, the CPU 40 determines whether a seeking operation is needed based on the calculated address difference. If it is determined that the seeking operation is needed, the operation moves to Step S221, otherwise, the operation moves to Step S223.

For example, the CPU 40 can determine the need of seeking operation by referring to a predetermined threshold value stored in the flash memory 39. If the address difference exceeds the threshold value, the CPU 40 may determine that the seeking operation is needed.

In step S221, the CPU 40 instructs the motor driver 27 to active the seek motor 22. The seek motor 22 performs seeking operation, and the process moves back to Step S215 to repeat Steps S215 to S221, until the address difference becomes within the threshold value.

In step S223, the CPU 40 determines whether the current address matches with the target address. If they are matched, the operation moves to Step S227, otherwise, the operation moves to Step S225 to obtain a current address and repeat Step S223.

In step S227, the CPU 40 instructs the encoder 25 to start recording the data onto the optical disc 15. With this instruction, the encoder 25 starts recording operation via the light controller 24 and the pickup device 23.

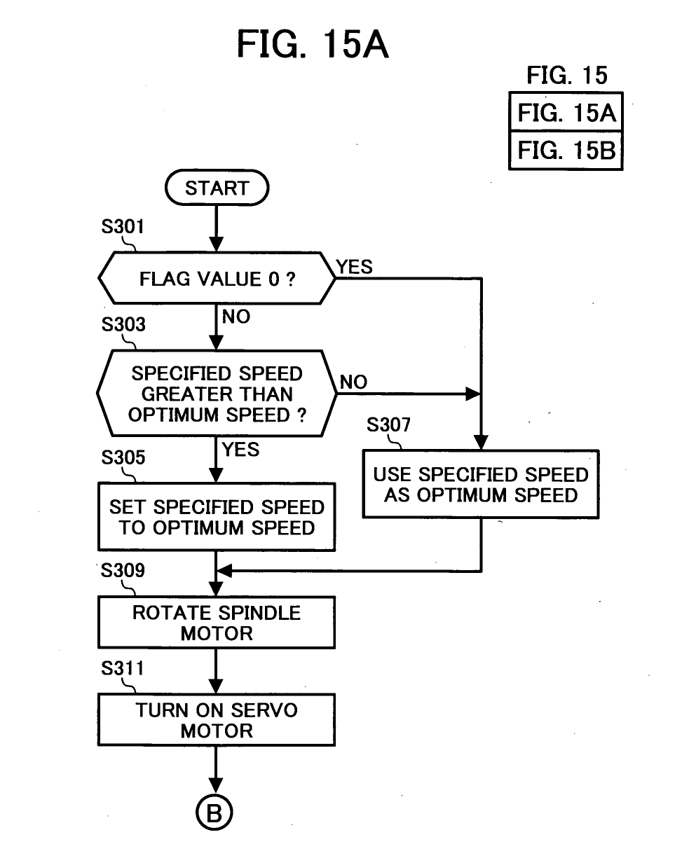

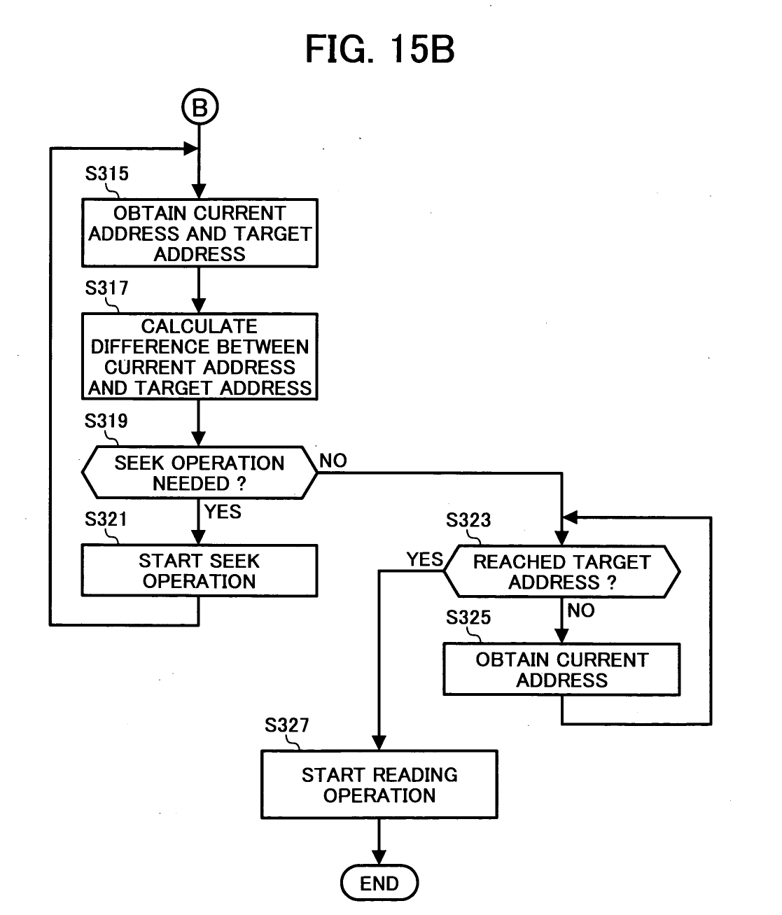

Next, a general operation of reading data from the optical disc 15, performed by the optical disc apparatus 20, is explained with reference to FIGS. 15A and 15B. The steps shown in FIGS. 15A and 15B are performed by the CPU 40 according to the data reading program stored in the flash memory 39. More specifically, when the CPU 50 receives a command from a user to read data from the optical disc 15 at a specified rotational speed, the data reading program is loaded from the flash memory 39 onto the RAM 41. At the same time, the CPU 40 starts operating according to the data reading program.

In step S301 of FIG. 15A, the CPU 40 determines whether the flag value indicates 0. If yes, the process moves to Step S307 to determine to use the specified rotational speed as the optimum rotational speed, and further to Step S309. Otherwise, the process moves to Step S303.

In step S303, the CPU 40 determines whether the specified rotational speed is greater than the optimum rotational speed that has been previously determined in the steps shown in any one of FIGS. 11 to 13. If no, the process moves to Step S307. Otherwise, the process moves to Step S305.

In step S305, the CPU 40 determines to use the optimum rotational speed as the optimum rotational speed.

In step S309, the CPU 40 instructs the motor controller 29 to rotate the optical disc 15 at the optimum rotational speed. The CPU 40 then notifies the signal processor 28 that the command for reading data has been received.

In step S311, after the CPU 40 determines that the rotational speed of the optical disc 15 has reached the optimum rotational speed, the CPU 40 actives the servo controller 33. The servo controller 33 controls the pickup device 23 through focusing and tracking operations.

In step S315 of FIG. 15B, the CPU 40 obtains a current address based on the address information output from the decoder 28e of the signal processor 28, and a target address from the received command.

In step S317, the CPU 40 calculates the address difference between the current address and the target address.

In step S319, the CPU 40 determines whether a seeking operation is needed based on the calculated address difference, in a similar manner as described referring to Step S219 of FIG. 14. If it is determined that the seeking operation is needed, the operation moves to Step S321, otherwise, the operation moves to Step S323.

In step S321, the CPU 40 instructs the motor driver 27 to active the seek motor 22. The seek motor 22 performs a seeking operation, and the process moves back to Step S315 to repeat Steps S315 to S321, until the address difference becomes within the threshold value.

In step S323, the CPU 40 determines whether the current address matches with the target address. If they are matched, the operation moves to Step S327, otherwise, the operation moves to Step S325 to obtain a current address and repeat Step S323.

In step S327, the CPU 40 instructs the signal processor 28 to start reading the data from the optical disc 15. With this instruction, the signal processor 28 receives the reproduced data, and stored it in the buffer memory 34. The reproduced data may be transferred via the buffer manager 37 and the interface 38 to a host apparatus (not shown), for example.

Numerous additional modifications and variations are possible in light of the above teachings. It is therefore to be understood that within the scope of the appended claims, the disclosure of this patent specification may be practiced otherwise than as specifically described herein.

For example, elements and/or features of different illustrative embodiments may be combined with each other and/or substituted for each other within the scope of this disclosure and appended claims.

Further, any one of the disc speed controlling program, data writing program, and data reading program may be stored in any kind of storage device, including optical discs, magneto optical discs, memory card, flexible discs, etc. Further, any one of the above programs may be downloaded from another storage device via a network, including an LAN, an intranet, the Internet, etc.

In addition to CDs and DVDs, the optical disc 15 may include, for example, a hybrid disc including a RAM section and a ROM section. In such a case, any one of the programs may be previously written in the ROM section.

Furthermore, it is not required for the optical disc apparatus 20 to perform all the functions including writing, reading, and erasing data. The optical disc apparatus 20 needs to perform at least one of the described functions, as long as it can suppress the eccentricity influence. Further, the structures and operations described referring to the optical disc apparatus 20 are provided for the descriptive purposes. Thus, different structures and different operations may be applied to the optical disc apparatus 20, as will be apparent to those skilled in the art, within the scope of this disclosure and appended claims.

In particular, the pickup device 23 may be formed with a different structure, capable of suppressing its mechanical vibrations. This may be achieved by using different types of suspension models, for example.

1. An optical disc apparatus, comprising:
a driving mechanism configured to rotate an optical disc at a specified rotational speed;
a lighting mechanism configured to emit a light to the optical disc through a focusing mechanism, and receive a reflected light from the optical disc; and
an eccentricity detecting mechanism configured to detect eccentricity of the optical disc, using positional information of the focusing mechanism extracted from the reflected light; and
a speed controlling mechanism configured to adjust the specified rotational speed according to the eccentricity.

2. The optical disc apparatus of claim 1, wherein the driving mechanism includes:
a motor controller configured to generate a control signal;
a motor driver configured to generate a drive signal corresponding to the control signal; and
a spindle motor configured to rotate the optical disc according to the drive signal.

3. The optical disc apparatus of claim 1, wherein the lighting mechanism includes:
a pickup device having at least one semiconductor laser, capable of emitting a laser beam.

4. The optical disc apparatus of claim 1, further comprising:
a tracking mechanism configured to adjust the position of the focusing mechanism in a tracking direction.

5. The optical disc apparatus of claim 4, wherein the tracking mechanism includes:
a servo controller configured to generate a tracking control signal;
a pickup driver configured to generate a tracking drive signal according to the tracking control signal.

6. The optical disc apparatus of claim 4, wherein the eccentricity detecting mechanism includes:
a processor configured to generate a servo-off signal for stopping the operation of the tracking mechanism, when the reflected light is extracted.

7. The optical disc apparatus of claim 6, wherein the focusing mechanism includes an objective lens.

8. The optical disc apparatus of claim 7, wherein the positional information includes a lens position signal, which indicates a vibration of the objective lens in a tracking direction.

9. The optical disc apparatus of claim 8, wherein the eccentricity detecting mechanism further includes:
a photodetector configured to convert the reflected light to an electric signal;
an amplifier configured to convert the electric signal to a voltage signal; and
a lens position signal detector configured to extract the lens position signal from the voltage signal.

10. The optical disc apparatus of claim 8, wherein the eccentricity detecting mechanism further includes:
an amplitude extractor configured to extract an amplitude of the lens position signal.

11. The optical disc apparatus of claim 10, wherein the eccentricity is made proportional to the amplitude of the lens position signal.

12. The optical disc apparatus of claim 10, wherein the eccentricity is made proportional to the square root mean of the lens position signal.

13. The optical disc apparatus of claim 8, wherein the eccentricity detecting mechanism further includes:
a band pass filter configured to extract only a frequency component of the lens position signal, which corresponds to the specified rotational speed.

14. The optical disc apparatus of claim 13, wherein the eccentricity detecting mechanism further includes:
an amplitude extractor configured to extract an amplitude of the frequency component of the lens position signal.

15. The optical disc apparatus of claim 14, wherein the eccentricity is made proportional to the amplitude of the frequency component.

16. The optical disc apparatus of claim 14, wherein the eccentricity is made proportional to the square root mean of the frequency component.

17. The optical disc apparatus of claim 1, wherein the speed controlling mechanism includes:
a processor configured to determine whether the eccentricity is greater than a predetermined value.

18. The optical disc apparatus of claim 17, wherein the processor sets a flag to a first state when the determination result indicates that the eccentricity is greater than the predetermined value, and sets the flag to a second state when the determination result indicates that the eccentricity is equal to or less than the predetermined value.

19. The optical disc apparatus of claim 17, wherein the processor calculates an optimum rotational speed of the optical disc, when the determination result indicates that the eccentricity is greater than the predetermined value

20. The optical disc apparatus of claim 19, wherein the speed controlling mechanism changes the specified rotational speed to the optimum rotational speed, when the determination result indicates that the eccentricity is greater than the predetermined value.

21. The optical disc apparatus of claim 1, wherein the controlling mechanism includes:
a processor configured to determine a high rotational speed and a low rotational speed based on a specification of the optical disc,
wherein the specified rotational speed includes the high rotational speed and the low rotational speed, and the positional information includes high positional information corresponding to the high rotational speed and low positional information corresponding to the low rotational speed.

22. The optical disc apparatus of claim 21, wherein the processor generates adjusted positional information based on a difference between the high positional information and the low positional information, and
the eccentricity detecting mechanism uses the adjusted positional information as the positional information.

23. The optical disc apparatus of claim 1, further comprising:
a storage device configured to store recorded data to be recorded onto the optical disc;
an encoder configured to generate a writing signal according to the recorded data; and
a light controller configured to control the lighting mechanism based on the writing signal.

24. The optical disc apparatus of claim 1, further comprising:
a data reading mechanism configured to generate reproduced data based on the reflected light; and
a storage device configured to store the reproduced data.

25. The optical disc apparatus of claim 1, further comprising:
an interface configured to allow the optical disc apparatus to communicate with other devices by a network.

26. The optical disc apparatus of claim 4, further comprising:
a processor; and
a storage device configured to store a plurality of instructions which, when executed by the processor, causes the processor to perform an operation including:
stopping an operation of the tracking mechanism, when the reflected light is extracted;
rotating the optical disc at the specified rotational speed, using the driving mechanism;
obtaining the positional information of the focusing mechanism, using the eccentricity detecting mechanism;
calculating eccentricity of the optical disc based on the positional information; and
controlling the specified rotational speed based on the eccentricity, using the speed controlling mechanism.

27. A method for determining an optimum rotational speed of an optical disc, comprising the steps of:
stopping a tracking control operation of an objective lens;
rotating the optical disc at a specified rotational speed;
obtaining a lens position signal indicating a vibration of the objective lens in a tracking direction;
calculating eccentricity of the optical disc based on the lens position signal; and
determining an optimum rotational speed of the optical disc based on the eccentricity.

28. The method of claim 27, further comprising the step of:
extracting an amplitude of the lens position signal,
wherein the eccentricity is calculated based on the amplitude.

29. The method of claim 28, wherein the eccentricity is made proportional to the amplitude of the lens position signal.

30. The method of claim 28, wherein the eccentricity is made proportional to the root mean square of the amplitude of the lens position signal.

31. The method of claim 27, further comprising the step of extracting only a frequency component of the lens position signal, corresponding to the specified rotational speed.

32. The method of claim 31, further comprising the step of extracting an amplitude of the frequency component of the lens position signal, wherein the eccentricity is calculated based on the amplitude.

33. The method of claim 32, wherein the eccentricity is made proportional to the amplitude of the frequency component.

34. The method of claim 32, wherein the eccentricity is made proportional to the root mean square of the amplitude of frequency component.

35. The method of claim 27, further comprising the step of:
determining whether the eccentricity is greater than a predetermined value,
wherein the optimum rotational speed is set based on the determination result.

36. The method of claim 35, wherein the determination step sets a flag to a first state when the determination result indicates that the eccentricity is greater than the predetermined value, and sets the flag to a second state when the determination result indicates that the eccentricity is equal to or less than the predetermined value.

37. The method of claim 35, wherein the determining step calculates the optimum rotational speed, when determination result indicates that the eccentricity is greater than the predetermined value.

38. The method of claim 27, further comprising the step of:
determining a high rotational speed and a low rotational speed based on a specification of the optical disc,
wherein the specified rotational speed includes the high rotational speed and the low rotational speed, and the lens position signal includes a high lens position signal corresponding to the high rotational speed and a low lens position signal corresponding to the low rotational speed.

39. The method of claim 38, further comprising the step of:
generating an adjusted lens position signal based on a difference between the high lens position signal and the low lens position signal,
wherein the calculating step uses the adjusted lens position signal as the lens position signal.

40. A method for controlling a rotational speed of an optical disc, comprising the steps of:
stopping a tracking control operation of an objective lens;
rotating the optical disc at a specified rotational speed;
obtaining a lens position signal indicating a vibration of the objective lens in a tracking direction;
calculating eccentricity of the optical disc based on the lens position signal; and
controlling the specified rotational speed based on the eccentricity.

41. The method of claim 40, further comprising the step of:
extracting an amplitude of the lens position signal, wherein the eccentricity is calculated based on the amplitude.

42. The method of claim 41, wherein the eccentricity is made proportional to the amplitude of the lens position signal.

43. The method of claim 41, wherein the eccentricity is made proportional to the root mean square of the amplitude of the lens position signal.

44. The method of claim 40, further comprising the step of extracting only a frequency component of the lens position signal, corresponding to the specified rotational speed.

45. The method of claim 40, further comprising the step of extracting an amplitude of the frequency component of the lens position signal, wherein the eccentricity is calculated based on the amplitude.

46. The method of claim 45, wherein the eccentricity is made proportional to the amplitude of the frequency component.

47. The method of claim 45, wherein the eccentricity is made proportional to the root mean square of the amplitude of frequency component.

48. The method of claim 40, further comprising the step of:
determining whether the eccentricity is greater than a predetermined value.

49. The method of claim 48, wherein the determination step sets a flag to a first state when the determination result indicates that the eccentricity is greater than the predetermined value, and sets the flag to a second state when the determination result indicates that the eccentricity is equal to or less than the predetermined value.

50. The method of claim 48, further comprising the step of:
calculating an optimum rotational speed, when the determination result indicates that the eccentricity is greater than the predetermined value.

51. The method of claim 50, wherein the controlling step changes the specified rotational speed to the optimum rotational speed, when the determination result indicates that the eccentricity is greater than the predetermined value.

52. The method of claim 40, further comprising the step of:
determining a high rotational speed and a low rotational speed based on a specification of the optical disc,
wherein the specified rotational speed includes the high rotational speed and the low rotational speed, and the lens position signal includes a high lens position signal corresponding to the high rotational speed and a low lens position signal corresponding to the low rotational speed.

53. The method of claim 51, further comprising the step of:
generating an adjusted lens position signal based on a difference between the high lens position signal and the low lens position signal, and
the calculating step uses the adjusted lens position signal as the lens position signal.

54. The method of claim 40, further comprising the step of:
writing data onto the optical disc.

55. The method of claim 40, further comprising the step of:
reading data from the optical disc.

56. A computer program product stored on a computer readable storage medium for carrying out a method, when run on an apparatus, the method comprising the steps of:
stopping a tracking control operation of an objective lens;
rotating the optical disc at a specified rotational speed;
obtaining a lens position signal indicating a vibration of the objective lens in a tracking direction;
calculating eccentricity of the optical disc based on the lens position signal; and
determining an optimum rotational speed of the optical disc based on the eccentricity.

57. A computer program product stored on a computer readable storage medium for carrying out a method, when run on an apparatus, the method comprising the steps of:
stopping a tracking control operation of an objective lens;
rotating the optical disc at a specified rotational speed;
obtaining a lens position signal indicating a vibration of the objective lens in a tracking direction;
calculating eccentricity of the optical disc based on the lens position signal; and
controlling the specified rotational speed based on the eccentricity.

58. The product of claim 57, wherein the method further comprises the step of:
extracting an amplitude of the lens position signal, and wherein the eccentricity is calculated based on the amplitude.

59. The product of claim 58, wherein the eccentricity is made proportional to the amplitude of the lens position signal.

60. The product of claim 58, wherein the eccentricity is made proportional to the root mean square of the amplitude of the lens position signal.

61. The product of claim 57, wherein the method further comprises the step of:
extracting only a frequency component of the lens position signal, corresponding to the specified rotational speed.

62. The product of claim 61, wherein the method further comprises the step of:
extracting an amplitude of the frequency component of the lens position signal, and
wherein the eccentricity is calculated based on the amplitude.

63. The product of claim 62, wherein the eccentricity is made proportional to the amplitude of the frequency component.

64. The product of claim 62, wherein the eccentricity is made proportional to the root mean square of the amplitude of frequency component.

65. The product of claim 57, wherein the method further comprises the step of:
determining whether the eccentricity is greater than a predetermined value.

66. The product of claim 65, wherein the determination step sets a flag to a first state when the determination result indicates that the eccentricity is greater than the predetermined value, and sets the flag to a second state when the determination result indicates that the eccentricity is equal to or less than the predetermined value.

67. The product of claim 65, wherein the method further comprises the step of:
calculating an optimum rotational speed, when the determination result indicates that the eccentricity is greater than the predetermined value.

68. The product of claim 67, wherein the controlling step changes the specified rotational speed to the optimum rotational speed, when the determination result indicates that the eccentricity is greater than the predetermined value.

69. The product of claim 57, wherein the method further comprises the step of:
determining a high rotational speed and a low rotational speed based on a specification of the optical disc,
and wherein the specified rotational speed includes the high rotational speed and the low rotational speed, and the lens position signal includes a high lens position signal corresponding to the high rotational speed and a low lens position signal corresponding to the low rotational speed.

70. The product of claim 69, wherein the method further comprises the step of:
generating an adjusted lens position signal based on a difference between the high lens position signal and the low lens position signal,
and wherein the calculating step uses the adjusted lens position signal as the lens position signal.

71. The method of claim 57, wherein the method further comprises the step of:
writing data onto the optical disc.

72. The method of claim 57, wherein the method further comprises the step of:
reading data from the optical disc.

73. A computer readable medium storing computer instructions for performing a method, the method comprising the steps of:
stopping a tracking control operation of an objective lens;
rotating the optical disc at a specified rotational speed;
obtaining a lens position signal indicating a vibration of the objective lens in a tracking direction;
calculating eccentricity of the optical disc based on the lens position signal; and
determining an optimum rotational speed of the optical disc based on the eccentricity.

74. A computer readable medium storing computer instructions for performing a method, the method comprising the steps of:
stopping a tracking control operation of an objective lens;
rotating the optical disc at a specified rotational speed;
obtaining a lens position signal indicating a vibration of the objective lens in a tracking direction;
calculating eccentricity of the optical disc based on the lens position signal; and
controlling the specified rotational speed based on the eccentricity.
